(19) United States
(12) Patent Application Publication
(10) Pub. No.: US 2007/0045012 A1
(43) Pub. Date: Mar. 1, 2007

(54) Vehicle system and method for accessing denied terrain

(75) Inventors: Wayne M. Brehob, Dearborn, MI (US); Douglas C. MacKenzie, Livonia, MI (US)

Correspondence Address: MOBILE INTELLIGENCE CORPORATION, 33150 SCHOOLCRAFT ROAD, WUITE 108, LIVONIA, MI, 48150, US

(73) Assignee: Mobile Intelligence Corporation

(21) Appl. No.: 11/214,378

(22) Filed: Aug. 29, 2005

(51) Int. Cl. B62D 51/06

(52) U.S. Cl. 180/8.2

(57) ABSTRACT

A surface vehicle capable of overcoming obstacles is disclosed in which the vehicle accelerates vertically while having a horizontal velocity. The vehicle has a frame and at least three wheels attached to the frame to which a horizontal propulsion system is coupled. Further, a vertical propulsion system is coupled to the frame and the wheels. The vertical propulsion system is capable of providing a force to such wheels normal to the surface so that the vehicle separates from the surface. The vehicle has an electronic control unit coupled to the vertical propulsion system to automatically control its operation.

### FIELD OF THE INVENTION

The present invention relates to a vehicle capable of overcoming obstacles such as fences, ledges, boulders, rivers, and ditches. In particular, the vehicle accelerates vertically while having a horizontal velocity.

### BACKGROUND OF THE INVENTION

A surface vehicle is a device that transports itself and a payload from place to place on the surface of the earth or other celestial body. Such vehicles can lose their mobility when encountering obstacles: positive obstacles which stick up from the average surface, such as logs, boulders, fences; negative obstacles such as holes, ledges, or ditches; and non-supportive surfaces such as rivers, ponds, or swamp muck. The inventors of the present invention have recognized that it would be desirable to have a surface vehicle which is not limited by such obstacles.

Prior art vehicles, such as motorcycles, are capable of overcoming obstacles; however, they require a ramp to impart a vertical component of velocity. This is impractical for free roaming vehicles for which it is desirable to overcome any obstacle encountered regardless of the presence of a ramp.

A prior art vehicle capable of imparting a vertical acceleration to the vehicle is a low rider, in which hydraulic cylinders are energized to cause the vehicle to rise and fall. There are several disadvantages of a low rider vehicle for the purpose of traversing an obstacle. Typically, not all wheels of the low rider leave the ground, or if they do, either the rear or front wheels leave the ground only a small distance. The low rider does not provide sufficient acceleration to cause the vehicle to leave the ground an appreciable distance with a single actuation of the hydraulic cylinders. Instead, the cylinders are bounced at a resonant frequency to cause the vehicle to attain a significant vertical height with multiple actuations of the hydraulic cylinders. Such operation does not allow a low rider vehicle to clear an obstacle. Additionally, the control of the hydraulic cylinders is controlled remotely by a human operator. Moreover, the low rider is not adapted to provide significant vertical acceleration when the vehicle is translating on the ground. Instead, the highest vertical heights are achieved when the vehicle is not translating. Yet another disadvantage for the low rider in overcoming a positive obstacle is that the wheels are actuated in a downward direction to cause the vehicle to accelerate upward. With the wheels at their lowest extent possible, they would be the limiting factor for such a vehicle in clearing a positive obstacle.

Rockets and jet propulsion are used to generate vertical acceleration in known devices. However, both require a large amount of energy to provide the acceleration. Although they might be used to clear one or a few obstacles, they are impractical for clearing multiple obstacles that a vehicle might encounter simply because the fuel needs are too great.

### SUMMARY OF THE INVENTION

Disadvantages of prior art surface vehicles are overcome by a surface vehicle system having a frame, at least three members coupled to the frame, and a horizontal propulsion system coupled to the frame. The horizontal propulsion system provides motive force to at least one of the members to cause the vehicle to translate along the surface. The vehicle further includes a vertical propulsion system coupled to the frame and the members, which is capable of providing a force to the members generally normal to the surface to cause all members to lift off the surface. The vehicle includes an electronic control unit coupled to the vertical propulsion system to automatically control operation of the vertical propulsion system. In one embodiment, the members are wheels. In an alternative embodiment, the members are tracks.

In one embodiment, the vertical propulsion system includes a hydraulic cylinder capable of developing a large, controlled vertical force between the members in contact with the ground and the body of the vehicle for sufficient time to accelerate the vehicle in a substantially vertical direction to launch it free of the surface. The vertical force is applied while the vehicle is at a controlled speed horizontally. Thereby, the vehicle can be propelled over an obstacle. The vertical force is sufficient to cause the vehicle to attain more than 1 g of acceleration such that it lifts from the surface. The term ‘g’ refers to the acceleration of gravity, which is 9.8 m/s² for earth. This gravitational constant is different for alternative celestial bodies.

By being separated from contact with the surface to a significant height for a significant period of time during which it moves a controlled distance horizontally, the vehicle returns to the surface having traversed the obstacle. Since it does this without recourse to aerodynamic lift, yet another advantage of the present invention is that the vehicle doesn't need large surfaces that make the vehicle wide, or rocket propulsion that is too energy intensive to be practical for a vehicle without a long duration mission.

Yet another advantage of the present invention is in evasive maneuvers. Should there be a moving obstacle, such as another vehicle in the vicinity that is out of control, the vehicle of the present invention can provide a higher acceleration rate vertically than the less than 1 g acceleration rate that can be generated horizontally. Thereby, a collision with an errant vehicle or other moving mass can be avoided by jumping upward.

Another advantage of the present invention is that the vehicle can be accelerated vertically in a single actuation without the need for a ramp, as required by jumping cars or motorcycles, or an energy-intensive rocket propulsion device.

A method is also disclosed for operating a vehicle in which a vertical propulsion device is actuated. The vertical propulsion device is coupled between a frame of the vehicle and members in contact with the ground. The actuation of the vertical propulsion device causes the members to apply a substantially normal force of sufficient magnitude to the surface that the resulting acceleration of the vehicle is greater than 1 g. The entire vehicle lifts off the ground by a single actuation of the vertical propulsion device. The method further includes retracting the wheels toward the frame after the members are no longer in contact with the ground, particularly in clearing a positive obstacle. Further, the members are extended away from the frame after the vehicle has cleared the positive obstacle and before the vehicle impacts the ground. In one alternative, the propulsion device is a hydraulic cylinder. A valve in the hydraulic cylinder is adjusted to provide damping as the vehicle impacts the surface. In another alternative, the vertical propulsion device is an internal combustion cylinder. Each member is equipped with a vertical propulsion device.

In one embodiment, the members are wheels and the vehicle includes a horizontal propulsion device, which applies a torque to rotate at least one of the wheels to cause the vehicle to translate along the ground.

The method also includes detecting an obstacle over which the vehicle cannot travel if it remains substantially in contact with the ground. In response to detecting the obstacle, a signal is provided to actuate the vertical propulsion device. The detection is inputted to and the actuating signal is provided by an onboard electronic controller electronically coupled to the vertical propulsion device. The horizontal propulsion device is also electronically coupled to the electronic control unit. The electronic controller commands the horizontal propulsion system to actuate the horizontal propulsion device to attain a predetermined translational velocity prior to actuating the vertical propulsion device so that the vehicle clears the obstacle. The obstacle is a positive obstacle, a negative obstacle, or a non-supportive surface.

The method described in the present invention allows determination of whether the vehicle can clear the obstacle prior to actuating the vertical propulsion device, thereby mitigating a collision with the obstacle. If it is determined that the obstacle could be cleared if the vehicle had a higher translational velocity, the vehicle can approach the obstacle for a second time after having attained that higher velocity. If it is determined that the obstacle cannot be cleared, the vehicle is commanded to find a more favorable location. In one alternative, a test of surface condition is made to determine whether the surface is sufficiently stable to support the applied downward force of the members to accelerate the vehicle vertically. This is done by sensing the reaction of the vehicle and members to a known pulse of the vertical propulsion system.

Other features and advantages of the present invention will be apparent from the accompanying drawings, and from the detailed description that follows below

### BRIEF DESCRIPTION OF THE DRAWINGS

The invention will now be described further by way of example only and with reference to the accompanying drawings in which:

FIG. 1 is an elevation schematic of a jumping vehicle according to an aspect of the present invention;

FIG. 2 is a plan schematic of a jumping vehicle according to an aspect of the present invention in which an example of a horizontal propulsion system is shown;

FIG. 3 is a plan schematic of a jumping vehicle according to an aspect of the present invention in which an example of a vertical propulsion system operated hydraulically is shown;

FIG. 4 is an illustration of a first half of a jump sequence for a jumping vehicle in overcoming a positive obstacle;

FIG. 5 is an illustration of a second half of a jump sequence for a jumping vehicle after overcoming a positive obstacle;

FIG. 6 is a schematic of a jumping vehicle according to an aspect of the present invention; and

FIG. 7 is a schematic of a plan view of the vehicle showing wheel base and track width.

### DETAILED DESCRIPTION

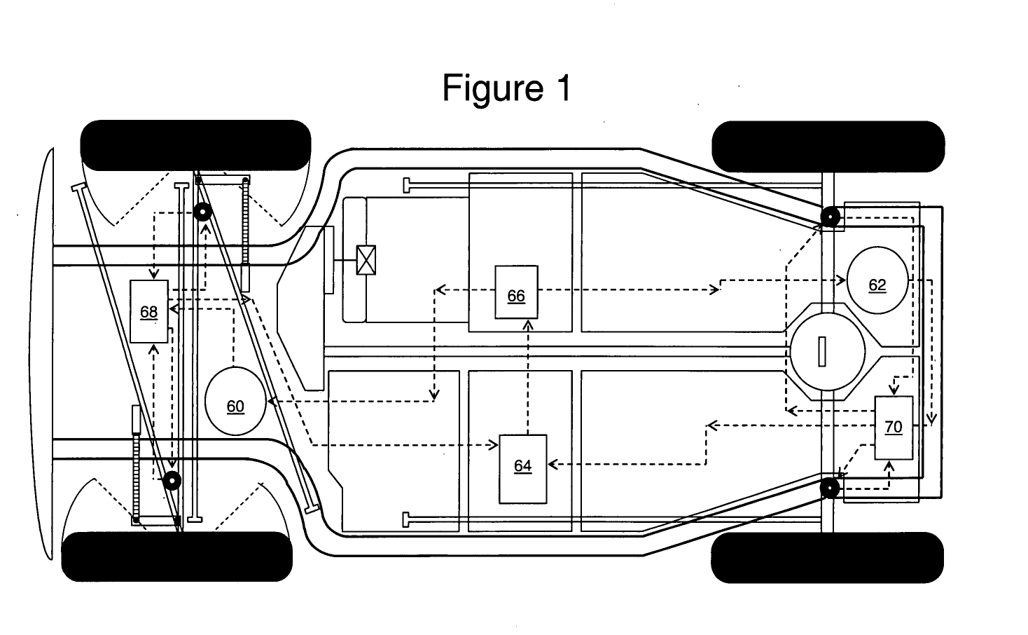

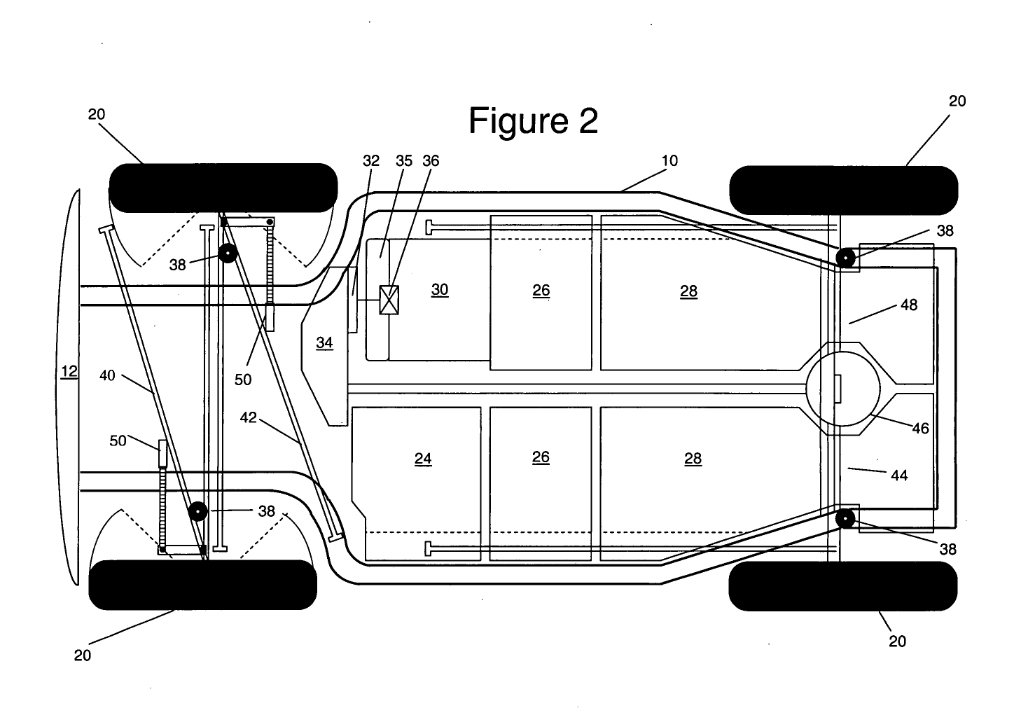

A vehicle according to the present invention is shown in FIGS. 1 and 2, FIG. 1 being an elevation view and FIG. 2 being a plan view. The vehicle has a frame 10 to which three or more members are connected. In the present example, there are 4 members and the members are wheels 20. The front wheels are connected to the frame by A-arms: the left front wheel via A-arm 40 and the right front wheel via A-arm 42 (shown in FIG. 2 only). The left hand front wheel is slightly forward of the right hand left wheel to accommodate A-arms 42 being in a plane without contacting each other. Also, A-arm 42 connected to the right hand wheel angles toward the rear of the vehicle and A-arm 42 connected to the left hand wheel angles toward the front of the vehicle. The rear wheels are mounted on a solid axle 48 connected to frame 10 by radius arms 24 and lateral control link 22. Steering of the front wheels is accomplished by linear actuators 50 mounted to A-arms 40, 42 and connected to steering knuckles 13. Steering knuckles 13 are attached to the front knuckles on which wheel spindles are mounted. The vehicle is propelled horizontally, i.e., along the surface, by an engine 30, which in one embodiment is an internal combustion engine, gasoline or diesel. Engine 30 is coupled to a motor generator 35 via a dog clutch 32. The shaft from motor generator 35 is connected to a transmission 34 through a clutch 32. Transmission 34 is connected to driveshaft 18 which connects to the differential 46 in rear axle 48 which drives the rear wheels 20. The drivetrain shown in FIGS. 1 and 2 is a hybrid configuration. In a non-hybrid embodiment, engine 30 connects to transmission 34 through clutch 32. Both embodiments of the vehicle use a battery 24. A higher capacity battery is used for the hybrid application. A battery for a non-hybrid version is sized to start engine 30 and to supply any onboard accessories.

The horizontal propulsion system may be a steam engine, a Stirling cycle engine, a gas turbine engine, a reciprocating internal combustion engine, such as a gasoline engine (often referred to as Otto cycle), a diesel engine, and variants including: 2-stroke, 4-stroke, homogeneous charge compression ignition or any other known type.

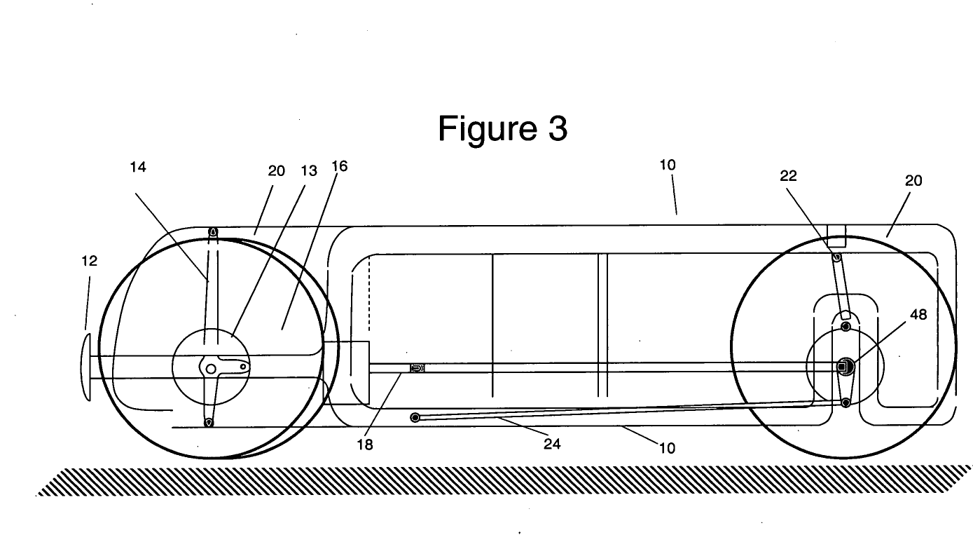

Referring now to FIG. 3, an embodiment of a hydraulic vertical propulsion system is shown. The hydraulic vertical propulsion system is also included in the vehicle shown in FIGS. 1 and 2. However, for the sake of simplicity, the mechanical and hydraulic systems are highlighted separately in the two views. The hydraulic system includes a hydraulic fluid reservoir 64 which supplies hydraulic fluid to hydraulic pump 66. Hydraulic pump 66 is driven off engine 30. In another embodiment, an electric motor is used to drive pump 66. High pressure hydraulic fluid is supplied to accumulators, front 60 and rear 62. In an alternate embodiment, a single accumulator could be used. The front accumulator 60 is connected to the front hydraulic control valve 68; similarly, accumulator 62 is connected to rear hydraulic control valve 70. The hydraulic control valves supply hydraulic fluid to the vertical propulsion cylinders 38 or hydraulic struts. The lines between the hydraulic control valves and the vertical propulsion cylinders 38 connect to both ends of the vertical propulsion cylinders 38: supplying fluid to one end of vertical propulsion cylinder 38 causes wheels 20 to extend from frame 10 and supplying fluid to the other end of vertical propulsion cylinder 38 causes wheels 20 to retract toward frame 10. Hydraulic fluid return lines connect from vertical propulsion cylinders 38 to reservoir 64.

If the terrain over which vehicle 8 is traveling is uneven, it is desirable to have independent control of each wheel. As shown in FIG. 3, front wheels 20 have control valve 68 and rear wheels have control valve 70, which can be independently controlled. In an alternate embodiment, vehicle 8 is equipped with a control valve for each wheel.

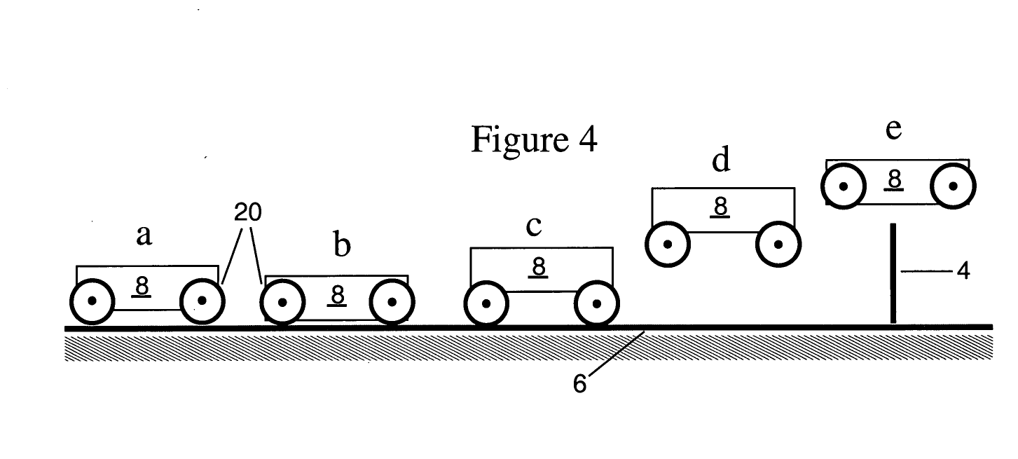

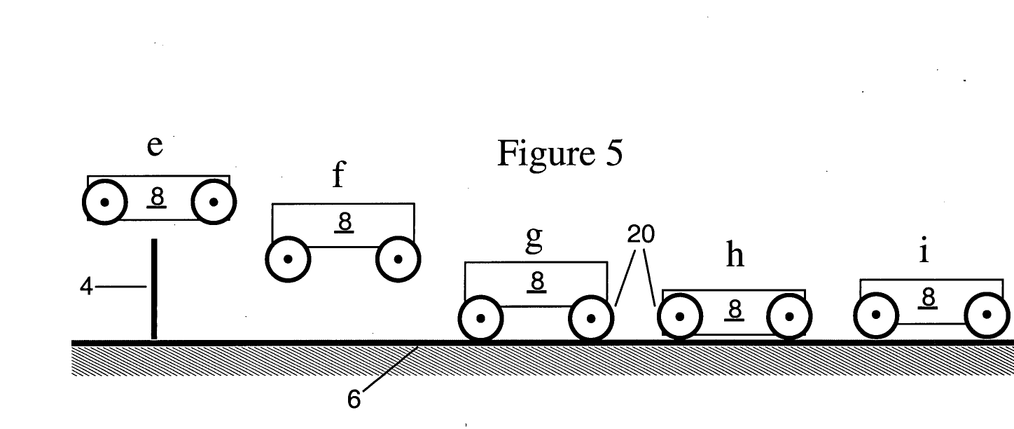

Referring now to FIGS. 4 and 5, the phases of a jump over a positive obstacle are shown. Vehicle 8 is traveling normally in phase a, in which the suspension is not fully retracted to allow for ground clearance of the vehicle. Vehicle 8 translates along the surface at a forward velocity of 20 kilometers per hour (kph). In preparation for a jump, wheels 20 are retracted to cause vehicle 8 to hunker down toward ground 6, as shown in phase b. The vertical propulsion system is actuated causing wheels 20 to exert a downward force toward ground 6 forcing wheels 20 to separate from frame 10. In reaction, vehicle 8, is accelerated vertically, and rises, shown as phase c. While wheels 20 are in contact with surface 6 as shown in phase c, they continue to exert a downward force. When vehicle 8 reaches the limit of the suspension travel, wheels 20 lift off the ground as they are carried up with vehicle 8. Phase d shows a time after wheels 20 have come off ground 6 and remain extended. To clear obstacle 4, wheels 20 are retracted toward vehicle 8, as shown in phase 3. Continuing with FIG. 5, after clearing obstacle 4, wheels 20 can be extended from vehicle 8 to prepare for touchdown, as shown in phase f. At phase g, wheels 20 of vehicle 8 have contacted ground 6. In phase h, the suspension has compressed to cushion the landing with ground 6. In phase i, the suspension is extended to achieve its standard ground clearance.

In the event that the obstacle being traversed is a negative obstacle, such as a chasm, or a neutral obstacle such as a ravine, vehicle 8 proceeds as shown in FIGS. 4 and 5, except that in step e, there is no need to retract the wheels. It is better not to retract the wheels to save the energy that would otherwise be expended in retracting and then later lowering the wheels in step f. In this case, the vehicle reaches the apogee of the jump at step e; however, the relative position of vehicle 8 and the wheels remains nearly constant through steps d through f.

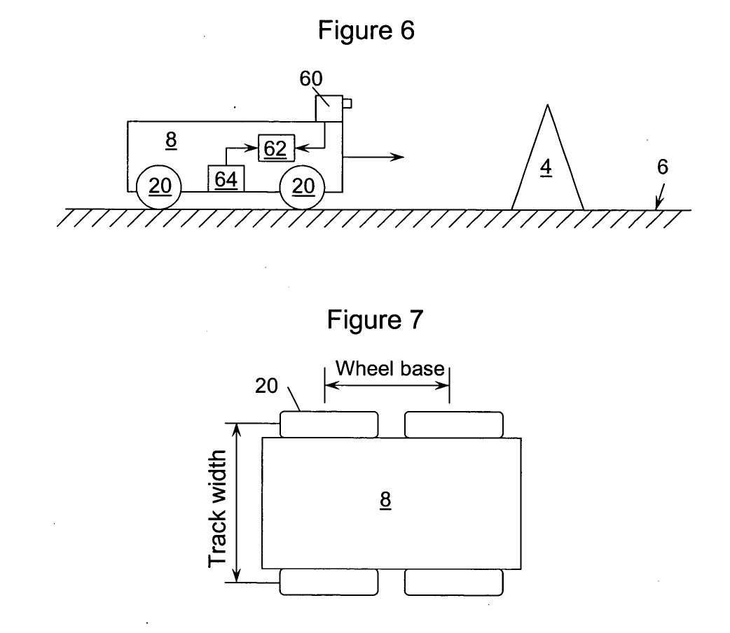

In FIG. 6, vehicle 8 is moving in the direction of obstacle 4. Vehicle 8 is equipped with electronic control unit 62, which is in communication with image capture unit 62 and sensors 64. Images from unit 62 can be analyzed to determine that vehicle 8 is approaching an obstacle. Sensors 64 can include various sensors which can be used to infer the condition of surface 6. Sensors 64 can act from a distance by measuring radiative properties of the surface, surface irregularities, as a couple of examples. Sensors 64 can have an extendable arm (not shown) which can be used to impact surface 6 to determine its ability to support members 20 in making a jump. In one embodiment, sensors 64 collect a small amount of soil from surface 6 and make an onboard determination of the properties of surface 6.

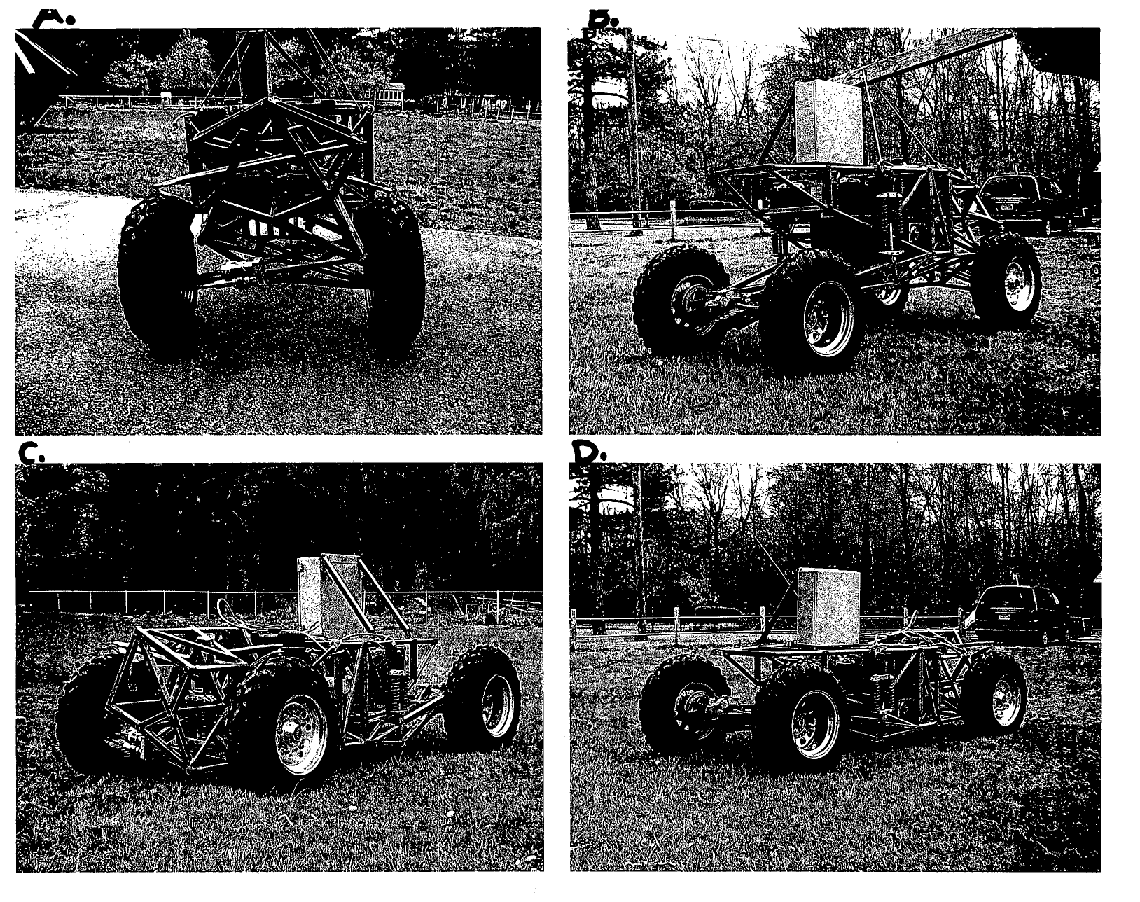

In FIG. 7, the wheel base and track width are shown in a plan view of vehicle 8.

Although not shown in the figures, electronic control unit 62, or another electronic control unit similar to unit 62 is electronically coupled to both the vertical and horizontal propulsion systems to actuate hydraulic cylinders 38, control arms 40 and 42, and engine 30. Electronic control unit obtains information from engine 30, sensors 64 (providing, for example but not limited to, ambient condition signals, fuel signals, vehicle payload signals, vehicle condition signals such as relative position of frame 10 with respect to wheels 20) sensors associated with the vertical propulsion system, sensors associated with the steering mechanism, etc. From these signals, engine 30 controls the vertical propulsion system, the horizontal propulsion system, and the steering mechanism of vehicle 8 to allow it to traverse terrain which would otherwise be unattainable for vehicle 8.

While the present invention has been described, those skilled in the art will appreciate various changes in form and detail may be made without departing from the intended scope of the present invention as defined in the appended claims.

We claim:

1. A surface vehicle system, comprising:
a frame;
at least three members coupled to said frame;
a horizontal propulsion system coupled to said frame and at least one of said members, said horizontal propulsion system adapted to provide motive force between said member and the surface to cause the vehicle to translate along the surface;
a vertical propulsion system coupled between said frame and said members, said vertical propulsion system adapted to provide a force to said members generally normal to the surface wherein a vertical travel of said members with respect to the frame exceeds 0.2 of a characteristic dimension of the vehicle and said characteristic dimension is an average of a track width and a wheelbase of the vehicle; and
an electronic control unit electronically coupled to said vertical propulsion system adapted to automatically control operation of said vertical propulsion system.

2. The system of claim 1 wherein said members are wheels.

3. The system of claim 1, further comprising: a steering mechanism coupled to at least one of said members.

4. The system of claim 1 wherein a vertical acceleration greater than 1 g is achieved by actuating said vertical propulsion system exactly once.

5. The system of claim 4 wherein said vertical acceleration is greater than 2 gs.

6. The system of claim 1 wherein said vertical propulsion device is actuated in response to said vehicle encountering an obstacle.

7. The system of claim 1 wherein said vertical propulsion system comprises at least one of a hydraulic cylinder and an internal combustion cylinder.

8. The system of claim 1 wherein said vertical propulsion system comprises at least one hydraulic cylinder and said horizontal propulsion system comprises an internal combustion engine, the system further comprising:
a hydraulic pump coupled to said hydraulic cylinder and to said internal combustion engine; and
a hydraulic fluid accumulator coupled to said hydraulic pump.

9. The system of claim 8, further comprising: a valve coupled to said hydraulic cylinder and electronically coupled to said electronic control unit, whereby opening position of said valve is adjusted to control damping of the vehicle upon impact with the surface.

10. A method to operate a vehicle, comprising: actuating a vertical propulsion device, said vertical propulsion device being coupled between a frame of the vehicle and a member of the vehicle in contact with the ground wherein a single actuation of said vertical propulsion device causes said member to apply a substantially normal force to the surface such that the resulting vertical acceleration of the vehicle is greater than 1 g.

11. The method of claim 10 wherein said member is a wheel.

12. The method of claim 10 wherein said actuation of said vertical propulsion device is in response to said vehicle encountering a positive obstacle, the method further comprising: retracting said member when said member is no longer in contact with the ground.

13. The method of claim 12, further comprising: extending said member after said obstacle is cleared and prior to landing on the ground.

14. The method of claim 11 wherein said vertical propulsion system comprises at least one hydraulic cylinder, the method further comprising: adjusting a valve coupled to said hydraulic cylinder prior to the vehicle impacting the surface so as to control the impact.

15. The method of claim 11 wherein said vehicle also has a horizontal propulsion system coupled between said frame and said wheel adapted to propel the vehicle along the ground and an electronic control unit coupled to said horizontal propulsion system and said vertical propulsion system.

16. The method of claim 10 wherein said member of the vehicle lifts off the ground by a single actuation of said vertical propulsion device.

17. The method of claim 10, the method further comprising:
detecting an obstacle over which the vehicle cannot propel itself if remaining substantially in contact with the ground; and
providing a signal to cause said actuation of said vertical propulsion device wherein said detection is inputted to and said actuation is provided by an onboard electronic controller coupled to said vertical propulsion system, such signal being provided in response to detecting said obstacle.

18. The method of claim 15, further comprising: extending said wheel away from said frame after the vehicle has cleared a positive obstacle and before the vehicle impacts the ground.

19. The method of claim 10 wherein said vertical acceleration is greater than 2 gs.

20. The method of claim 10 wherein said vertical propulsion device is hydraulic cylinder.

21. The method of claim 10 wherein the vehicle has a plurality of members and an internal combustion cylinder is coupled between each member and the frame.

22. The method of claim 15, the method further comprising:
detecting an obstacle over which the vehicle cannot propel itself if remaining substantially in contact with the ground;
providing a signal to cause said actuation of said vertical propulsion device wherein said detection is inputted to and said actuation is provided by an onboard electronic controller; and
commanding said horizontal propulsion device to attain a predetermined translational velocity prior to said actuation of said vertical propulsion device so that the vehicle clears said obstacle.

23. The method of claim 22 wherein said obstacle is one of a positive obstacle, a negative obstacle, and a non-supportive surface.

24. The method of claim 22, further comprising: controlling said actuation of said vertical propulsion device based on the obstacle to be overcome and a ground surface condition.

25. The method of claim 24 wherein a ground surface condition is detected during a first portion of said actuation based on at least one of force of said actuation, mass of the vehicle, and relative motion between said member and said frame.

26. The method of claim 22 wherein characteristics of said obstacle are computed in said electronic controller based on signals received from an image capture unit coupled to said electronic controller.

27. The method of claim 22, further comprising:
pulsing said vertical propulsion device prior to said actuation of the vertical propulsion device; and
estimating a ground surface condition based on a relative motion between said member and said frame as a result of said pulsing.

28. The method of claim 22 wherein a ground surface condition is estimated based on signals from sensors coupled to the vehicle and said electronic controller.

29. A method to operate a vehicle, comprising:
sensing an obstacle obstructing a desired path of the vehicle;
actuating a vertical propulsion device coupled to the vehicle in response to said sensing.

30. The method of claim 29 wherein said vertical propulsion device is coupled between a frame of the vehicle and a member of the vehicle which is in contact with the ground wherein such actuation of said vertical propulsion device causes said member to apply a substantially normal force to the surface such that the resulting acceleration of the vehicle is greater than 1 g.

31. The method of claim 29, further comprising: commanding a horizontal propulsion system coupled to the vehicle to provide motive force to the vehicle in a generally horizontal direction.

32. A surface vehicle system, comprising:
a frame;
at least three members coupled to said frame;
a horizontal propulsion system coupled to said frame and at least one of said members, said horizontal propulsion system adapted to provide motive force between said member and the surface to cause the vehicle to translate along the surface; and
a vertical propulsion system coupled to said frame and said members, said vertical propulsion system adapted to provide a force to said members generally normal to the surface, said force being capable of imparting more than 1 g of vertical acceleration to the vehicle.
